(19) United States
(12) Patent Application Publication
(10) Pub. No.: US 2002/0169869 A1
(43) Pub. Date: Nov. 14, 2002

(54) SAN monitor incorporating a GPS receiver

(75) Inventors: James David Fainer, Silverado, CA (US); George Robert Parrett, Trabuco Canyon, CA (US)

Correspondence Address: HOGAN & HARTSON L.L.P., 500 S. GRAND AVENUE, SUITE 1900, LOS ANGELES, CA, 90071-2611, US

(73) Assignee: SHUGART TECHNOLOGY, INC.

(21) Appl. No.: 09/852,164

(22) Filed: May 8, 2001

(51) Int. Cl. G06F 15/16; G06F 15/173

(52) U.S. Cl. 709/224

(57) ABSTRACT

A device for monitoring a storage area network (SAN) that incorporates a global positioning system (GPS) receiver. The monitoring device (SAN monitor) generally includes a Fibre Channel interface for connecting to a Fibre Channel, a PCI interface for connecting to a PCI bus, a controller connected to the Fibre Channel interface and the PCI interface for controlling the functions of the SAN monitor, and a GPS receiver for receiving GPS satellite signals and providing a synchronized timing signal to the controller via a timer. When a plurality of SAN monitors deployed on the network at large distances from each other, the timing signals provided by the GPS receiver enables the monitors to sample data from the network in a synchronized manner.

### BACKGROUND OF THE INVENTION

1. Field of the Invention

This invention relates to devices for testing and monitoring storage area networks (SAN), and in particular, to such testing and monitoring devices incorporating a global positioning system (GPS) receiver.

2. Description of the Related Art

A storage area network (SAN) is a high-speed, high-bandwidth managed server-storage infrastructure that logically connects storage devices to servers. SANs powered by Fibre Channel technology far exceed the capabilities of traditional storage and throughput methods. Superior to traditional servers/storage connections in flexibility, availability, integrated management, performance, scalability and disaster tolerance, SANs are quickly becoming the solution of choice for high-volume data handling.

The global positioning system (GPS) is generally known. GPS receivers have been used for time synchronization in various communications systems. For example, U.S. Pat. No. 6,016,322 to Goldman describes utilizing GPS signals in wireless communication systems to synchronize data transmission by TDMA. U.S. Pat. No. 5,953,384 to Walsh describes a system using the 1 PPM GPS signal to synchronize various equipment, and deals with the problem of signal delay when the receiver and the equipment are connected by a cable. U.S. Pat. No. 5,854,793 to Dinkins describes the use of GPS receivers in a two-way communication network including central television transmitter stations and remote transmitter units (subscribers). U.S. Pat. No. 5,712,624 to Ayerst describes receiver synchronization in a radio communication system using the GPS system.

### SUMMARY OF THE INVENTION

SAN monitors—tools for monitoring, testing and analyzing the storage devices on the SAN—are being developed for the management and problem isolation of the network. SANs are often distributed over large geological areas, and SAN monitors are often deployed at various remote locations on the network. The present invention addresses the problem of synchronization of SAN monitors distributed over different locations and separated by large distances, by incorporating a GPS receiver in the SAN monitors.

An object of the present invention is to allow for the synchronization of the SAN monitor internal clocks, which are of a higher resolution, and allow multiple SAN monitors to sample the primitive low level protocol of the Fibre Channel no matter where the monitors are deployed. By having the sampling of this information (ordered sets) synchronized over large distances, the information that is captured can be used in a more meaningful manner.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a SAN monitoring device comprising a network interface adapted to be connected to the storage area network, a peripheral bus interface adapted to be connected to a peripheral bus, a controller connected to the network interface and the peripheral bus interface, and a GPS receiver connected to the controller for supplying a synchronized timing signal to the controller.

In another aspect, the present invention is a storage system comprising a storage area network and a plurality of monitoring devices connected to the network, each monitoring devices including a GPS receiver for supplying a synchronized timing signal to the receiver, and the plurality of monitoring devices sampling data from the network in a synchronized manner.

In yet another aspect, the present invention provides a method for monitoring a storage area network, comprising the steps of sampling information from the storage area network using a plurality of monitoring devices, receiving GPS timing signals by each monitoring device, and synchronizing the sampling of information by the plurality of monitoring devices using the received GPS timing signals.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a Fibre Channel network and a plurality of SAN monitor connected thereto.

FIG. 2 is a block diagram illustrating the structure of a SAN monitor incorporating a GPS received according to an embodiment of the present invention.

### DETAILED DESCRIPTION OF THE PREFERRED EMBODIMENTS

The following detailed description is provided using the Fibre Channel as an example of a storage area network (SAN). The invention is applicable to other types of SANs as well, such as Gigabit Ethernet or Infiniband. The claimed invention is intended to cover all such applications. The implementation details may differ for different types of networks, but such detains are within the purview of those skilled in the relevant art and the invention can be practices based on the description herein and the general knowledge in the art without undue experimentation.

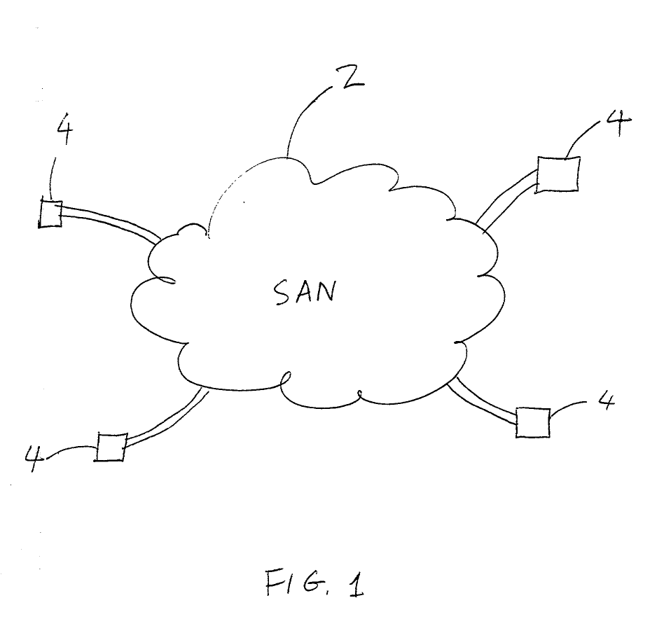

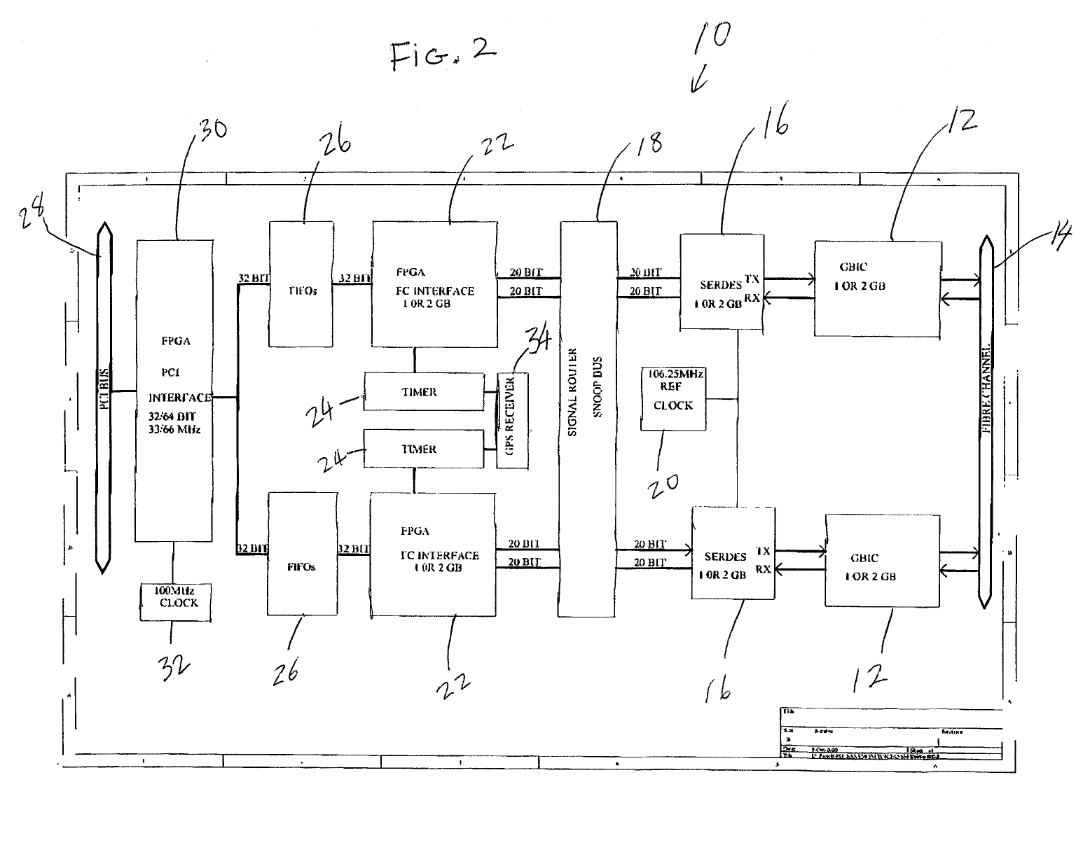

FIG. 1 is a schematic illustration of a Fibre Channel network 2 to which a plurality of SAN monitors 4 are connected. Each SAN monitor typically performs one or more monitoring tasks, including monitoring performance and traffic of the network, analyzing specific transfers by capturing all the data at a node, generating traffic to test specific links in the network, etc. Hereinafter, the term “monitoring” includes various functions such as monitoring, testing, analyzing and the like.

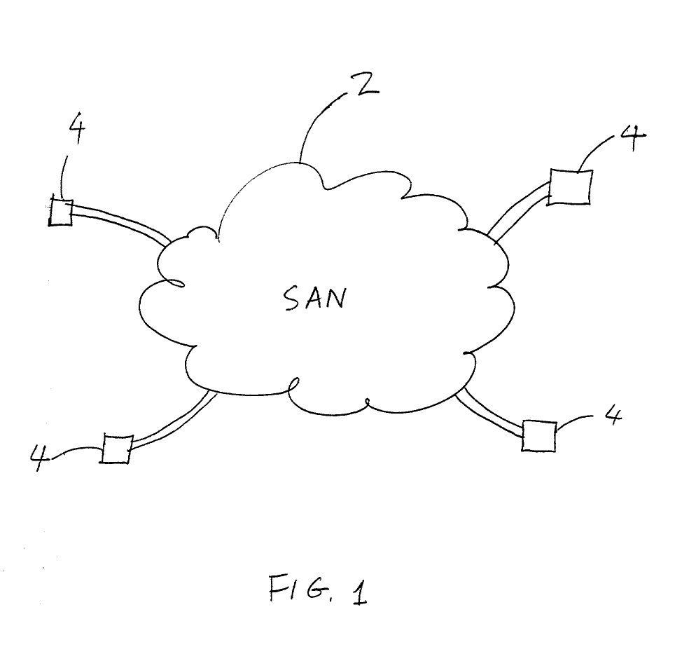

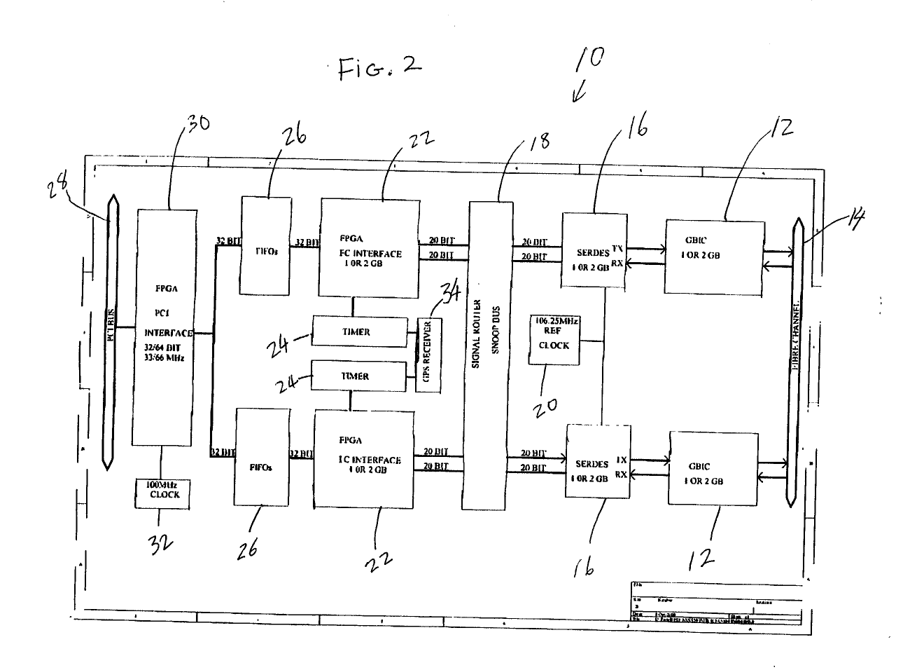

Referring to FIG. 2, a SAN monitor 10 according to an embodiment of the present invention includes a gigabyte interface converter (GBIC) 12 connected to the Fibre Channel 14, a serializer/deserializer (SERDES) 16 connected to the GBIC 12 as well as a signal router/snoop bus 18. A reference clock 20 is provided for the SERDES 16. A Fibre Channel controller (FC Interface) 22 is connected to the serial router 18, and is provided with a timer 24 for timing control. The Fibre Channel controller is used to examine details of the information being transmitted on the SAN (e.g. frames) to determine specific events. The events are time stamped using a counter, which is time synchronized using the GPS. Time stamping the events using timing information provided by the GPS receiver allows all events within a Global Fabric to be coordinated to one time reference. More specifically, the FC Interface decodes the 10b data to 8b data, and checks for various errors within the data as well as for Loss of Sync. It decodes the data and generates a signal when specific Ordered Sets are received. It signals start of frame which is time stamped. The frame is than examined in detail for specific conditions. These conditions are kept in a buffer table in various forms, and the table is than read by the system to determine the performance and health of the Fabric.

A FIFO 26 is connected to the Fibre Channel controller 22, and to a Peripheral Component Interconnect (PCI) bus 28 through a PCI bus interface 30. A clock 32 is provided for the PCI bus interface 28. The Fibre Channel controller 22 and the PCI bus interface 30 may be comprised of field programmable gate arrays (FPGA). The device shown in FIG. 1 is capable of fall duplex monitoring with certain components (GBIC 12, SERDES 16, FC controller 22, and FIFO 26) provided in duplex, but this is not essential for the SAN monitor.

In the embodiment of FIG. 1, a GPS (Global Positioning System) receiver 34 is provided to supply timing signals to the timers 24 that are connected to the FC controller 22. GPS satellites provide time references to determine accurate time referenced to either GPS time or Universal Time Coordinated (UTC). GPS receivers process the received satellite signals to provide a precise timing signal such as a 1 pulse-per-second (1 PPS) signal, referenced to either GPS time or UTC. The incorporation of a GPS receiver 34 in the SAN monitor 10 allows for the synchronization of the SAN monitor internal clock 24, which is of a higher resolution. This allows a plurality of SAN monitor's to sample the primitive low level protocol of the Fibre Channel in a synchronized manner, regardless of where the SAN monitor is deployed or how far the SAN monitors are located from each other. By having the sampling of this information (ordered sets) synchronized over large distances, the information that is captured can be used in a more meaningful manner.

It will be apparent to those skilled in the art that various modifications and variations can be made in the SAN monitor of the present invention without departing from the spirit or scope of the inventions. For example, in addition to Fibre Channel, the invention may be applied in a heterogeneous Wide Area Network (WAN) or a Global Network. Also, although a PCI bus is used as an example, the SAN monitor may be used with other peripheral buses. Further, the Fibre Channel controller 22 may be programmed to perform any desired monitoring function depending on the specific application. Thus, it is intended that the present invention cover modifications and variations of this invention that come within the scope of the appended claims and their equivalents.

What is claimed is:

1. A monitoring device adapted to be connected to a storage area network for monitoring the network, comprising:
a network interface adapted to be connected to the storage area network;
a controller connected to the network interface for controlling the functions of the monitoring device; and
a GPS receiver connected to the controller for supplying a synchronized timing signal to the controller.

2. The monitoring device of claim 1, wherein the controller is a field programmable gate array.

3. The monitoring device of claim 3, further comprising:
a serializer/deserializer connected to the network interface;
a serial router connected to the serializer/deserializer and to the controller;
a peripheral bus interface adapted to be connected to a peripheral bus;
a FIFO connected to the controller and to the peripheral bus interface; and
a timer connected to the controller and receiving the timing signals supplied by the GPS receiver.

4. The monitoring device of claim 3, wherein the network interface is a Fibre Channel interface for connecting to a Fibre Channel, and wherein the peripheral bus interface is a peripheral component interconnect (PCI) interface for connecting to a PCI bus.

5. A storage system comprising:
a storage area network; and
a plurality of monitoring devices connected to the network, each monitoring devices including a GPS receiver for supplying a synchronized timing signal to the receiver, and the plurality of monitoring devices sampling data from the network in a synchronized manner.

6. A method of monitoring a storage area network, comprising:
sampling information from the storage area network using a plurality of monitoring devices;
receiving GPS timing signals by each monitoring device; and
synchronizing the sampling of information by the plurality of monitoring devices using the received GPS timing signals.
